(19) United States
(12) Patent Application Publication
(10) Pub. No.: US 2026/0359259 A1
(43) Pub. Date: Nov. 12, 2026

(54) EXECUTION OF SINGLE INSTRUCTION MULTIPLE DATA (SIMD) INSTRUCTIONS ON A LANE-WISE OPERATED SIMD COPROCESSOR

(71) Applicant: QUALCOMM Incorporated, San Diego, CA (US)

(72) Inventor: Eric Wayne MAHURIN, Austin, TX (US)

(21) Appl. No.: 19/204,868

(22) Filed: May 12, 2025

(51) Int. Cl. G06F 15/80

(52) U.S. Cl. CPC G06F 15/8015

(57) ABSTRACT

Techniques described herein are directed to a processing system having a single instruction multiple data (SIMD coprocessor that includes a plurality of lanes, each respective lane of the plurality of lanes being decoupled from every other lane included in the plurality of lanes. The lane-wise SIMD coprocessor is configured to: receive a SIMD instruction; generate a plurality of instances of the SIMD instruction; broadcast each respective instance of the SIMD instruction to a respective lane of the plurality of lanes; and execute, for each respective instance of the SIMD instruction, one or more operations on respective data stored on the respective lane of the plurality of lanes independent of execution of the one or more operations on respective data stored on every other respective lane of the plurality of lanes.

### TECHNICAL FIELD

Aspects of the present disclosure generally relate to coprocessors and, more particularly, to decomposing single instruction, multiple data (SIMD) instructions on a lane-wise operated SIMD coprocessor.

### BACKGROUND

Coprocessors (e.g., hardware accelerators) may be used to support a main processor (e.g., central processing unit) of a processing system. For example, the main processor may offload computationally intensive tasks (e.g., matrix multiplication, vector processor) or applications to the coprocessor so that the main processor may perform more general-purpose processing. Coprocessors can perform tasks in parallel with the main processor, allowing for concurrent processing and faster execution of certain workloads (e.g., machine learning algorithms).

SIMD coprocessors have a parallel processing architecture that allows an operation to be simultaneously performed on multiple data elements. Thus, the parallel processing architecture allows SIMD coprocessors to efficiently process large data sets. SIMD coprocessors can, for example, include specialized instructions that may be optimized for vector operations (e.g., addition, multiplication).

### BRIEF SUMMARY

In one aspect, a processing system is provided. The processing system includes: a lane-wise single instruction multiple data (SIMD) coprocessor comprising: a plurality of instances of local memory, each respective instance of local memory being decoupled from every other instance of local memory; and a plurality of lanes, wherein each respective lane of the plurality of lanes is coupled to a respective instance of local memory, and wherein each respective lane of the plurality of lanes is decoupled from every other lane of the plurality of lanes. wherein the lane-wise SIMD coprocessor is configured to: receive a SIMD instruction; generate a plurality of instances of the SIMD instruction; broadcast each respective instance of the SIMD instruction to a respective lane of the plurality of lanes; and execute, for each respective instance of the SIMD instruction, one or more operations on respective data stored on the respective lane of the plurality of lanes independent of execution of the one or more operations on respective data stored on every other respective lane of the plurality of lanes.

In another aspect, a method performable by a SIMD coprocessor including a plurality of instances of local memory and a plurality of lanes, with each respective lane of the plurality of lanes coupled to a respective instance of the plurality of instances of local memory and each respective lane of the plurality of lanes decoupled from every other lane of the plurality of lanes is provided. The method includes: receiving a SIMD instruction; generating a plurality of instances of the SIMD instruction; broadcasting each respective instance of the SIMD instruction to a respective lane of the plurality of lanes of the SIMD coprocessor; and executing, for each respective instance of the SIMD instruction, one or more operations on respective data stored on the respective lane of the plurality of lanes independent of execution of the one or more operations on respective data stored on every other respective lane of the plurality of lanes.

In yet another aspect, a processing system is provided. The processing system includes: a lane-wise SIMD coprocessor comprising a plurality of lanes, each respective lane of the plurality of lanes being decoupled from every other lane included in the plurality of lanes, wherein the lane-wise SIMD coprocessor is configured to: receive a SIMD instruction; generate a plurality of instances of the SIMD instruction; broadcast each respective instance of the SIMD instruction to a respective lane of the plurality of lanes; and execute, for each respective instance of the SIMD instruction, one or more operations on respective data stored on the respective lane of the plurality of lanes independent of execution of the one or more operations on respective data stored on every other respective lane of the plurality of lanes.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a heterogeneous computing system including a main processor and a coprocessor according to various aspects of the present disclosure.

FIG. 2 depicts a SIMD coprocessor according to various aspects of the present disclosure.

FIG. 3 depicts a lane-wise SIMD coprocessor according to various aspects of the present disclosure.

FIG. 4 depicts connections between a memory device and SIMD lanes of a lane-wise SIMD register included in a lane-wise SIMD coprocessor according to various aspects of the present disclosure.

FIG. 5 depicts a system for performing intra-SIMD data movement for a lane-wise SIMD coprocessor according to various aspects of the present disclosure.

FIG. 6 depicts an example architecture for a lane-wise SIMD coprocessor according to various aspects of the present disclosure.

FIG. 7 depicts an example technique for processing a SIMD instruction on a lane-wise SIMD coprocessor according to various aspects of the present disclosure.

FIG. 8 depicts an example method for processing a SIMD instruction on a lane-wise SIMD coprocessor according to various aspects of the present disclosure.

FIG. 9 depicts an example processing system in which a heterogeneous computing system may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for processing mixed precision SIMD instructions on a lane-wise operated SIMD coprocessor.

SIMD coprocessors typically include multiple SIMD registers, which are a type of processor register that can hold multiple data elements of the same data type. In this manner, SIMD instructions can simultaneously perform the same operation (e.g., addition, multiplication, comparison, etc.) on all the data elements in a given SIMD register. SIMD registers typically hold the multiple data elements in a vector-like structure. Each of the data elements included in the vector-like structure may be referred to as a lane through which data/instructions may flow.

A SIMD register typically supports cross-lane operations which, for example, may involve movement of data elements within the SIMD register. To facilitate such cross-lane operations, the SIMD register may include hardware (e.g., data buses) that allows the different lanes of the SIMD register to be in data communication with one another. The hardware is typically complex and presents challenges associated with scaling the SIMD register so that SIMD coprocessors can accommodate larger data sets that may be associated with more complex tasks (e.g., executing machine learning algorithms).

Example aspects of the present disclosure are directed to a lane-wise operated SIMD coprocessor. The lane-wise operated SIMD coprocessor includes multiple lane-wise SIMD registers. However, in contrast to SIMD registers included in traditional SIMD coprocessors, the different lanes within each respective lane-wise SIMD register are decoupled from one another. In this manner, each respective lane-wise SIMD register does not support cross-lane operations and, as a result, does not include the hardware (e.g., multiple data buses) that is included in conventional SIMD registers to facilitate such cross-lane operations.

Thus, the lane-wise operated SIMD coprocessor according to aspects of the present disclosure may be scaled more efficiently compared to traditional SIMD coprocessors. More specifically, the number of lanes that are included in each respective lane-wise SIMD register of the lane-wise SIMD coprocessor may be scaled (e.g., increased) more easily compared to conventional SIMD registers, because each lane-wise SIMD register of the lane-wise operated SIMD coprocessor disclosed herein does not support intra-SIMD movement (that is, movement of data from one SIMD lane to another SIMD lane) and therefore do not include the additional hardware (e.g., data buses and interconnects) and complexity associated with implementing such hardware for intra-SIMD movement. Furthermore, since each of the lane-wise SIMD registers is substantially wider (e.g., includes many multiples the number of SIMD lanes) compared to traditional SIMD registers, the lane-wise SIMD coprocessor may have a greater compute density (e.g., about 8 times) than traditional SIMD coprocessors.

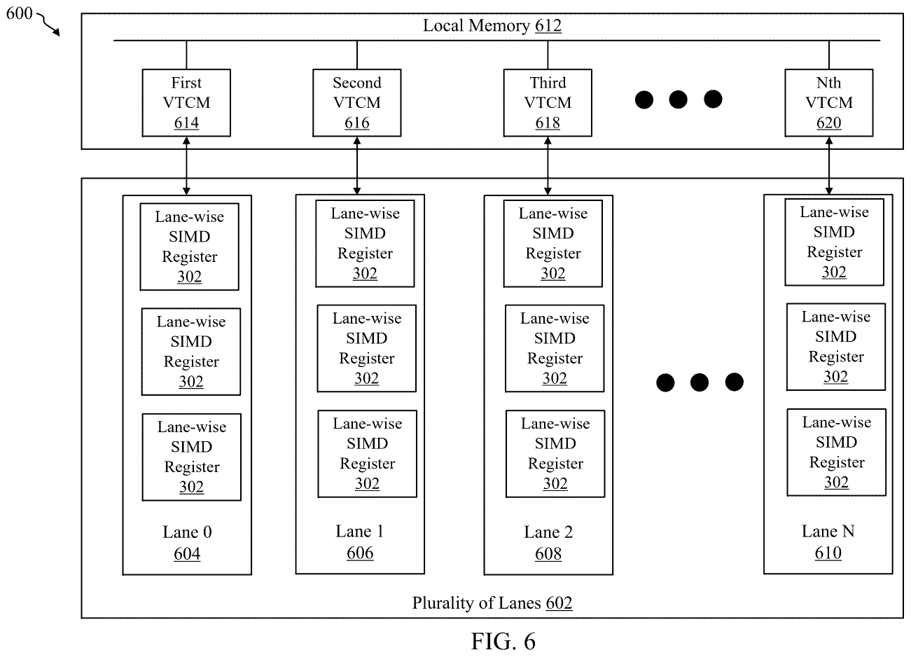

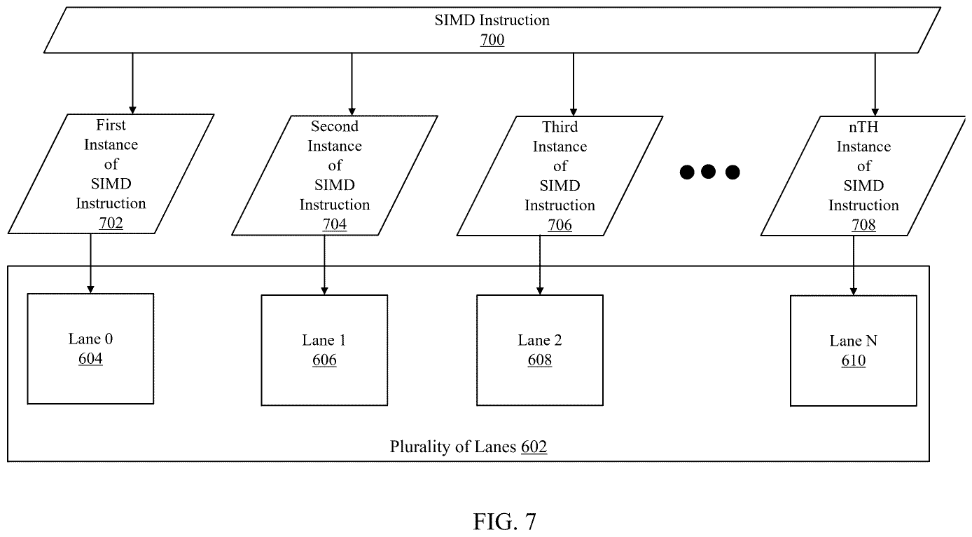

Example aspects of the present disclosure are directed to techniques for executing a SIMD instruction on lane-wise SIMD coprocessors. As will be discussed below in more detail with reference to FIG. 6 and FIG. 7, example techniques may allow SIMD instructions to be processed across multiple lanes of the lane-wise SIMD coprocessor and in any particular order without affecting a final result of the instruction streams. In this manner, example techniques for processing SIMD instructions according to the present disclosure allows lane-wise SIMD coprocessors to execute SIMD instructions more efficiently (e.g., faster) compared to processing the same SIMD instruction on traditional SIMD coprocessors having lanes that are interlocked with one another to support data movement between lanes thereof.

### Example Heterogeneous Computing System

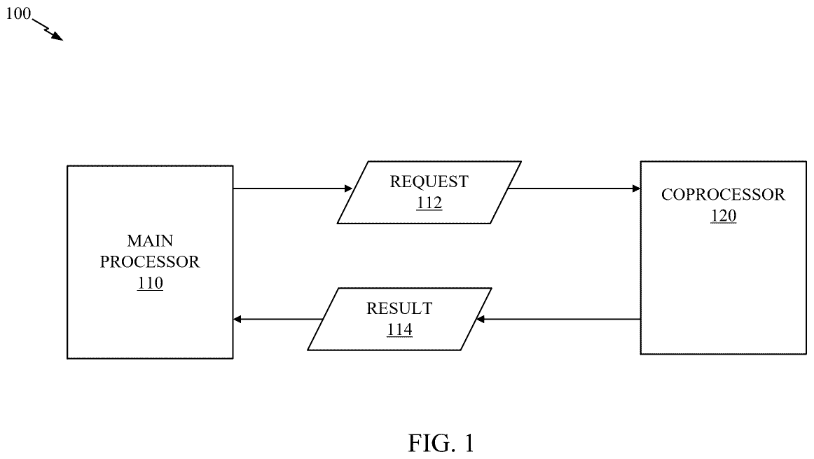

FIG. 1 depicts a heterogeneous computing system 100 according to aspects of the present disclosure. The heterogeneous computing system 100 may be used in a variety of different apparatuses (e.g., smartphones, tablets) and may be used for a variety of different applications (e.g., machine learning, digital signal processing, graphics processing). The heterogeneous computing system 100 includes a main processor 110 and a coprocessor 120. The main processor 110, which in some aspects may be a central processing unit (CPU), handles general-purpose computing tasks. The main processor 110 delegates computationally-intensive tasks (e.g., matrix multiplication, vector processing) to the coprocessor 120. Examples of the coprocessor(s) may include, without limitation, a graphics processing unit (GPU), a neural processing unit (NPU), and a tensor processing unit (TPU).

As illustrated, the main processor 110 may send a request 112 to the coprocessor 120. The request 112 may, for example, be for the coprocessor 120 to perform a computationally intensive task on data associated with a particular application (e.g., machine learning, digital signal processing) being executed by the heterogeneous computing system 100. The coprocessor 120 may communicate a result 114 of the computationally intensive task to the main processor 110.

### Example SIMD Coprocessor with SIMD Register Supporting Intra-SIMD Movement

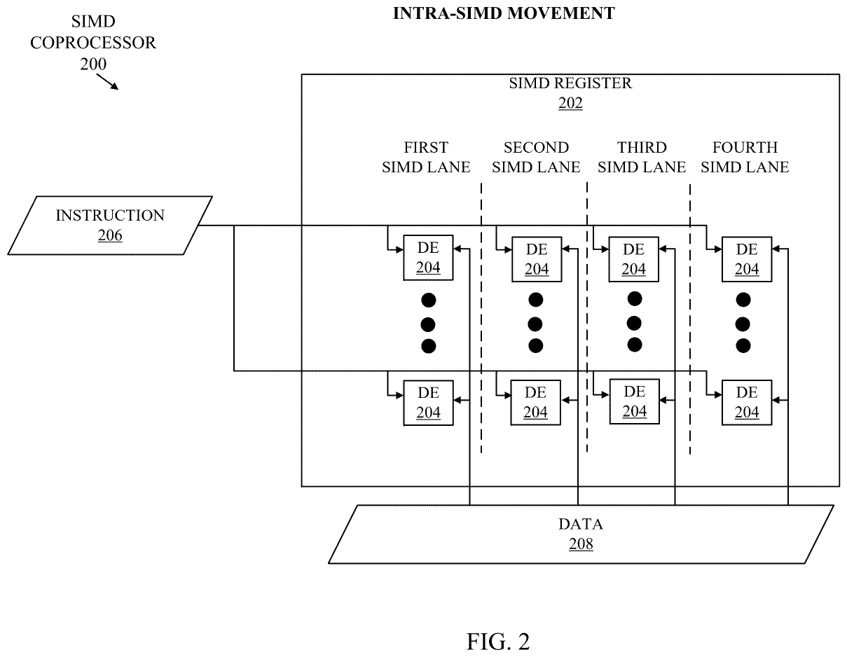

FIG. 2 depicts a SIMD coprocessor 200 according to aspects of the present disclosure.

The SIMD coprocessor 200 may include one or more SIMD registers 202 (one SIMD register 202 is shown in FIG. 2). Each of the SIMD registers 202 may include a plurality of SIMD data elements 204 (e.g., labeled “DE”). As illustrated, the plurality of SIMD data elements 204 may be arranged in an array (e.g., a vector arranged as columns and rows). Each respective column of the array may be referred to as a SIMD lane. In some aspects, each of the SIMD registers 202 may include four columns and four rows. In other aspects, each of the SIMD registers 202 may include more (or fewer) columns and rows. For instance, as illustrated in FIG. 2, each of the SIMD registers 202 may include a first SIMD lane, a second SIMD lane, a third SIMD lane, and a fourth SIMD lane.

In some aspects, the SIMD register 202 may be configured to receive an instruction 206 and data 208. More specifically, the instruction 206 may be provided as an input to each of the plurality of SIMD data elements 204. Additionally, a plurality of instances of data 208 may be provided as an input to each of the plurality of SIMD data elements 204.

The instruction 206 may correspond to an operation (e.g., multiply, add, etc.) that the SIMD registers 202 may simultaneously perform on the multiple instances of data 208. In some aspects, the operation may involve moving data between two respective SIMD lanes of the plurality of SIMD lanes included in the SIMD register 202. Such an operation may be referred to as a “cross-lane” operation. Furthermore, such movement of data (e.g., from one SIMD lane to another SIMD lane) may be referred to as “intra-SIMD” movement.

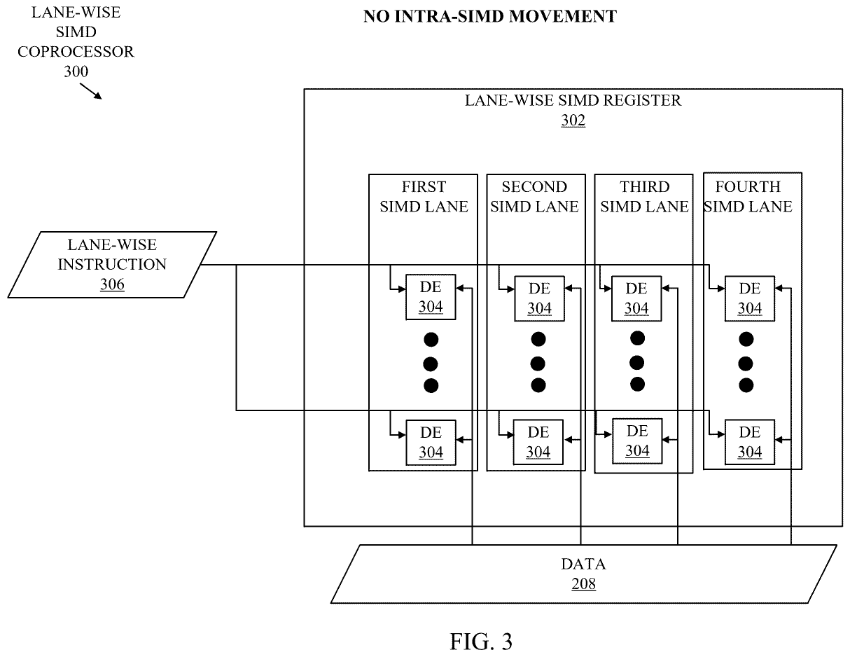

In some aspects, the SIMD register 202 may include hardware, such as dedicated data buses or interconnects, to facilitate intra-SIMD movement associated with cross-lane operations. As previously mentioned, SIMD registers, such as the SIMD register 202 of FIG. 2, that support cross-lane operations involving intra-SIMD movement may be difficult to scale. More specifically, the hardware associated with supporting cross-lane operations may become increasingly complex as the size (e.g., number of bits) of data increases. As will now be discussed with reference to FIG. 3, example aspects of the present disclosure are directed to a lane-wise SIMD coprocessor having a SIMD register that is configured for lane-wise only operations and therefore does not include the above-mentioned hardware for intra-SIMD movement and therefore can scale (e.g., to accommodate even larger data sets) more easily compared conventional SIMD coprocessors, such as the SIMD coprocessor 200 of FIG. 2.

### Example Lane-Wise SIMD Coprocessor with Lane-Wise SIMD Register Having No Intra-SIMD Movement

FIG. 3 depicts a lane-wise SIMD coprocessor 300 according to some aspects of the present disclosure.

The lane-wise SIMD coprocessor 300 may include one or more lane-wise SIMD registers 302 (one lane-wise SIMD register 302 is shown in FIG. 3). Each of the lane-wise SIMD registers 302 may include a plurality of SIMD data elements 304 (e.g., labeled “PU”). As illustrated, the plurality of SIMD data elements 304 may be arranged in an array (e.g., a vector arranged as columns and rows). Each respective column of the array may be referred to as a SIMD lane. In some aspects, each of the SIMD registers 302 may include four columns and four rows. In other aspects, each of the SIMD registers 302 may include more (or fewer) columns and rows. For instance, as illustrated in FIG. 3, each of the SIMD registers 302 may include a first SIMD lane, a second SIMD lane, a third SIMD lane, and a fourth SIMD lane. In other aspects, the lane-wise SIMD register 302 may include more or fewer SIMD lanes.

In some aspects, the lane-wise SIMD register 302 may be configured to receive a lane-wise instruction 306 and data 208. More specifically, the lane-wise instruction 306 may be provided as an input to each of the plurality of SIMD data elements 304. Additionally, a plurality of instances of data 208 may be provided as an input to each of the plurality of SIMD data elements 304.

The lane-wise instruction 306 may involve lane-wise operations that do not involve multiple SIMD lanes and therefore do not require intra-SIMD movement within the lane-wise SIMD register 302. It should be appreciated, however, that lane-wise operations may still include movement of data within a particular SIMD lane of the lane-wise SIMD register 302.

In contrast to the SIMD register 202 discussed above with reference to FIG. 2, the lane-wise SIMD register 302 in FIG. 3 does not include hardware, such as dedicated data buses or interconnects, to facilitate intra-SIMD movement associated with cross-lane operations. This is generally denoted by including a rectangular box around each of the plurality of SIMD lanes (e.g., First SIMD Lane, Second SIMD Lane, Third SIMD Lane, and Fourth SIMD Lane). In this manner, the lane-wise SIMD coprocessor 300, specifically the lane-wise SIMD register 302 thereof, may include less hardware compared to conventional SIMD coprocessors, such as the SIMD coprocessor 200 of FIG. 2, and therefore may scale (e.g., to accommodate even larger data sets) more easily compared conventional SIMD coprocessors.

The total number of SIMD lanes included in the lane-wise SIMD register 302 of FIG. 3 may be greater than the total number of SIMD lanes included in the SIMD register 202 of FIG. 2. For instance, in some aspects, the total number of SIMD lanes included in the lane-wise SIMD register 302 may be many multiples (e.g., at least 4 times as many) of the total number of SIMD lanes included in the SIMD register 202 of FIG. 2. For instance, in some aspects, the lane-wise SIMD register 302 may include as many as 1024 SIMD lanes. In this manner, the lane-wise SIMD coprocessor 300 may considered an ultra-wide SIMD coprocessor having no intra-SIMD movement within each of the lane-wise SIMD registers (e.g., lane-wise SIMD register 302) that are included in the lane-wise SIMD coprocessor 300.

As used herein, executing an instruction independent of a cross-lane operation occurring between the plurality of SIMD lanes of the lane-wise SIMD register 302 means that the instruction is executed within a single SIMD lane of the lane-wise SIMD register 302 and does not involve moving data from the single SIMD lane of the lane-wise SIMD register 302, nor does it involve retrieving data from another SIMD lane of the lane-wise SIMD register 302.

### Example Connections Between Memory and SIMD Lanes of Lane-wise SIMD Register

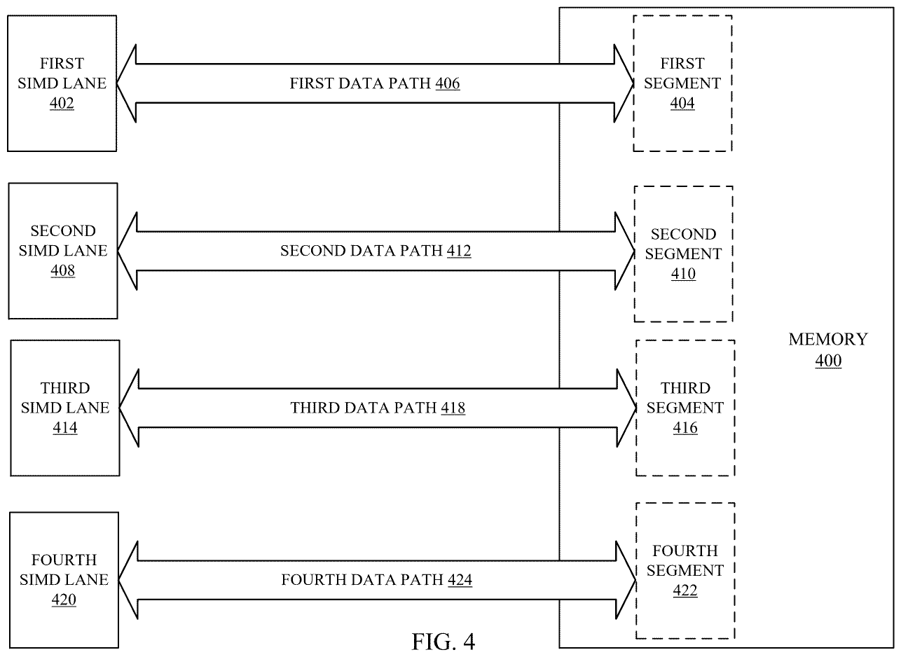

FIG. 4 depicts connections between memory 400 (e.g., main memory) and each of a plurality of SIMD lanes of a lane-wise SIMD register, such as the lane-wise SIMD register 302 of the lane-wise SIMD coprocessor 300 discussed above with reference to FIG. 3.

As illustrated, each of a first SIMD lane 402, a second SIMD lane 408, a third SIMD lane 414, and a fourth SIMD lane 420 may be in data communication with the memory 400 via independent data paths (e.g., denoted by double arrows extending between a respective SIMD lane and a respective segment of the memory 400). In some aspects, the data paths are decoupled from one another such that there is no data communication between two data paths extending between respective SIMD lanes and respective segments of the memory.

As illustrated, the first SIMD lane 402 may be in data communication with a first segment 404 of the memory 400 via a first data path 406. The second SIMD lane 408 may be in data communication with a second segment 410 of the memory 400 via a second data path 412 that is independent of the first data path 406. The third SIMD lane 414 may be in data communication with a third segment 416 of the memory 400 via a third data path 418 that is independent of the first data path 406 and the second data path 412. The fourth SIMD lane 420 may be in data communication with a fourth segment 422 of the memory 400 via a fourth data path 424 that is independent of each of the first data path 406, the second data path 412, and the third data path 418.

In some aspects, the different segments (e.g., first segment 404, second segment 410, third segment 416, and fourth segment 422) of the memory 400 may correspond to different address ranges of the memory 400. For instance, the first segment 404 of the memory 400 may correspond to a first subset of addresses of the memory 400, the second segment 410 may correspond to a second subset of addresses of the memory 400, the third segment 416 may correspond to a third subset of addresses of the memory 400, and the fourth segment 422 may correspond to a fourth subset of addresses of the memory. Furthermore, in some aspects, the different subsets of addresses (e.g., first subset, second subset, third subset, fourth subset) may be mutually exclusive. Stated another way, addresses included in one subset (e.g., first subset) of addresses of the memory 400 may not be included in any of the other subsets (e.g., second, third, fourth subsets) of the memory 400. In this manner, the different SIMD lanes (e.g., first SIMD lane 402, second SIMD lane 408, third SIMD lane 414, fourth SIMD lane 420) may be decoupled from one another (that is, not in data communication with one another) all the way to the memory 400.

Although FIG. 4 depicts four separate SIMD lanes, it should be appreciated that the connections between the memory 400 and a lane-wise SIMD register, such as the lane-wise SIMD register 302 of FIG. 3, may accommodate any suitable number of SIMD lanes. For instance, in some aspects, the lane-wise SIMD register may include 1024 different SIMD lanes. In such aspects, there may be 1024 separate data paths between the memory 400 and the lane-wise SIMD register to accommodate decoupling of the 1024 SIMD lanes all the way to the memory 400.

### Example System for Performing Data Movement for Lane-Wise SIMD Coprocessors

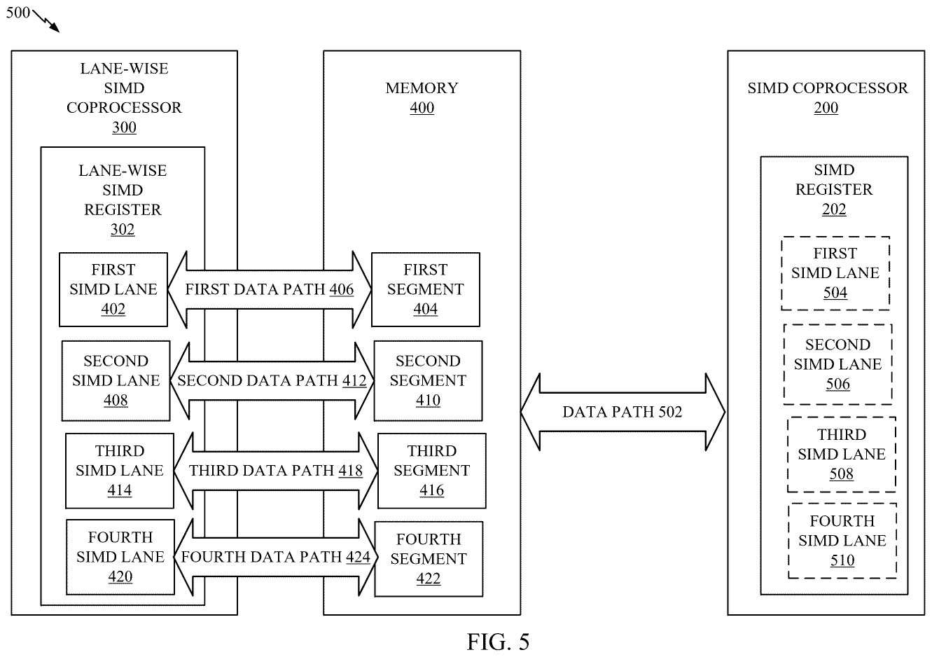

FIG. 5 depicts an example system 500 for performing data movement for lane-wise SIMD coprocessors according to some aspects of the present disclosure. For simplicity, the system 500 may include the lane-wise SIMD coprocessor 300 discussed above with reference to FIG. 3, the conventional SIMD coprocessor 200 discussed above with reference to FIG. 2, and the memory 400 discussed above with reference to FIG. 4.

In some aspects, intra-SIMD movement for the lane-wise SIMD register 302 of the lane-wise SIMD coprocessor 300 may be accomplished by moving data from the lane-wise SIMD coprocessor 300, which does not support intra-SIMD movement, to SIMD coprocessor 200, which does support intra-SIMD movement. As an example, to swap data included in the first SIMD lane 402 of the lane-wise SIMD register 302 with data included in the fourth SIMD lane 420 of the lane-wise SIMD register 302, data included in the first SIMD lane 402 may be communicated to the first segment 404 of the memory 400 via the first data path 406. Additionally, the data included in the fourth SIMD lane 420 of the lane-wise SIMD register 302 may be communicated to the fourth segment 422 of the memory 400 via the fourth data path 424.

As illustrated, the SIMD coprocessor 200, which does support intra-SIMD movement, may retrieve the data from the memory 400. For instance, the SIMD coprocessor 200 may retrieve data stored in the first segment 404 of the memory 400 as well as data stored in the fourth segment 422 of the memory 400. In some aspects, the SIMD coprocessor 200 may be in data communication with the memory 400 via a single data path 502. In other aspects, the SIMD coprocessor 200 may include multiple data paths between the memory 400 and respective SIMD lanes (e.g., first SIMD lane 504, second SIMD lane 506, third SIMD lane 508, and fourth SIMD lane 510) of the SIMD register 202 of the SIMD coprocessor 200.

In some aspects, the data retrieved from the first segment 404 of the memory 400 may be stored in the first SIMD lane 504 of the SIMD register 202. Additionally, the data retrieved from the fourth segment 422 of the memory 400 may be stored in the fourth SIMD lane 510 of the SIMD coprocessor 200.

In some aspects, the SIMD coprocessor 200 may be configured to execute one or more instructions associated with swapping the data stored in the first SIMD lane 504 of the SIMD register 202 with the data stored in the fourth SIMD lane 510 of the SIMD register 202. For instance, the SIMD coprocessor 200 may be configured to execute an instruction included in an instruction set architecture that supports intra-SIMD movement. It should be appreciated that the instruction executed by the SIMD coprocessor 200 to swap the data stored in the first SIMD lane 504 of the SIMD register 202 with the data stored in the fourth SIMD lane 510 of the SIMD register 202 may not be included in an instruction set architecture for the lane-wise SIMD coprocessor 300.

After executing the instruction to swap the data stored in the first SIMD lane 504 of the SIMD register 202 and the data stored in the fourth SIMD lane 510 of the SIMD register 202, the SIMD coprocessor 200 may be configured to return the data to the memory. For instance, the data now stored in the first SIMD lane 504 of the SIMD register 202 may be communicated to the memory 400 via data path 502 and ultimately stored in the first segment 404 of the memory 400. Additionally, the data now stored in the fourth SIMD lane 510 of the SIMD register 202 may be communicated to the memory 400 and ultimately stored in the fourth segment 422 of the memory 400.

With the data now loaded onto the memory 400, the lane-wise SIMD coprocessor 300 may execute one or more instructions included in an instruction set architecture for the lane-wise SIMD coprocessor 300. More specifically, the lane-wise SIMD coprocessor 300 may execute the instruction(s) to retrieve the data stored in the first segment 404 of the memory 400 and the data stored in the fourth segment 422 of the memory 400. More specifically, the data stored in the first segment 404 of the memory 400 may be communicated to the first SIMD lane 402 of the lane-wise SIMD register 302 via the first data path 406. Additionally, the data stored in the fourth segment 422 of the memory 400 may be communicated to the fourth SIMD lane 420 of the lane-wise SIMD register 302 via the fourth data path 424.

It should be appreciated that the data now stored in the first SIMD lane 402 of the lane-wise SIMD register 302 is the data that was previously stored in the fourth SIMD lane 420 of the lane-wise SIMD register 302. It should also be appreciated that the data now stored in the fourth SIMD lane 420 of the lane-wise SIMD register 302 is the data that was previously stored in the first SIMD lane 402 of the lane-wise SIMD register 302. Thus, the disclosed system 500 provides for intra-SIMD movement of data stored on the lane-wise SIMD register 302 of the lane-wise SIMD coprocessor 300 even though such movement is not supported by the lane-wise SIMD coprocessor 300.

### Example Architecture for Lane-Wise SIMD Coprocessor

FIG. 6 depicts an example architecture 600 for a lane-wise SIMD coprocessor according to certain aspects of the present disclosure. For example, the architecture 600 may be implemented in the lane-wise SIMD coprocessor 300 discussed above with

### Reference to Fig. 3.

As will be discussed below in more detail, the architecture 600 allows instruction streams to be processed across multiple lanes of the lane-wise SIMD coprocessor 300 and in any particular order without affecting a final result of the instruction streams. In this manner, the architecture 600 for the lane-wise SIMD coprocessor 300 is improved compared to traditional SIMD coprocessors, such as the SIMD coprocessor 200 of FIG. 2, that cannot process instruction streams across multiple lanes and in any particular order without affecting the final result of the instruction streams.

In some aspects, architecture 600 may include a plurality of lanes 602. As illustrated, each respective lane of the plurality of lanes 602 may include multiple instances of the lane-wise SMID register 302 discussed above with reference to FIG. 3. For instance, in some aspects, each respective lane of the plurality of lanes 602 may include three instances of the lane-wise SIMD coprocessor 302. In other aspects, each respective lane of the plurality of lanes 602 may include more or fewer instances of the lane-wise SIMD register 302. Alternatively, or additionally, one or more lanes of the plurality of lanes 602 may include multiple rows of the lane-wise SIMD coprocessor 302. It should be appreciated that the one or more lanes including multiple rows of the lane-wise SIMD register 302 may be referred to as a super lane.

Each respective lane of the plurality of lanes 602 is decoupled from every other lane of the plurality of lanes 602 such that there is no data movement from one lane of the plurality of lanes 602 to any other lane of the plurality of lanes 602. For example, a first lane 604 is decoupled from each of a second lane 606, a third lane 608, and an Nth lane 610 of the plurality of lanes 602 such that data in the first lane 604 of the plurality of lanes 602 cannot be moved to any other lane (e.g., second lane 606, third lane 608, Nth lane 610) of the plurality of lanes 602. Likewise, the second lane 606 is decoupled from each of the first lane 604, the third lane 608, and the Nth lane 610. Furthermore, the third lane 608 is decoupled from each of the first lane 604, the second lane 606, and the Nth lane 610 such that data in the second lane 606 of the plurality of lanes 602 cannot be moved to any other lane (e.g., first lane 604, third lane 608, Nth lane 610) of the plurality of lanes 602. Finally, the Nth lane 610 is decoupled from each of the first lane 604, the second lane 606, and the third lane 608 such that data in the Nth lane 610 of the plurality of lanes 602 cannot be moved to any other lane (e.g., first lane 604, second lane 606, third lane 608) of the plurality of lanes 602.

In some aspects, the architecture 600 may include a local memory 612. For instance, as illustrated in FIG. 6, the local memory 612 for the lane-wise SIMD coprocessor may include multiple instances of vector tightly coupled memory (VTCM), such as a first instance 614 of VTCM, a second instance 616 of VTCM, a third instance 618 of VTCM, and an Nth instance 620 of VTCM. It should be understood that the variable “N” refers to the last instance of VTCM included in the plurality of instances of VTCM that are included in the local memory 612.

In some aspects, each respective instance of the plurality of instances of the VTCM may be associated with a respective lane of the plurality of lanes 602. More specifically, each respective instance of the plurality of instances of the VTCM may be dedicated to a respective lane of the plurality of lanes 602. In this manner, each respective lane of the plurality of lanes 602 may read and write data from a respective instance of the multiple instances of the VTCM.

For example, the first instance 614 of the VTCM may be coupled to the first lane 604 of the plurality of lanes 602. In this manner, read and write operations occurring on the first lane 604 of the plurality of lanes 602 may involve accessing the first instance 614 of the VTCM. The second instance 616 of the VTCM may be coupled to the second lane 606 of the plurality of lanes 602. In this manner, read and write operations occurring on the second lane 606 of the plurality of lanes 602 may involve accessing the second instance 616 of the VTCM. The third instance 618 of the VTCM may be coupled to the third lane 608 of the plurality of lanes 602. In this manner, read and write operations occurring on the third lane 608 of the plurality of lanes 602 may involve accessing the third instance 618 of the VTCM. Finally, the Nth instance 620 of the VTCM may be coupled to Nth lane 610 of the plurality of lanes 602. In this manner, read and write operations occurring on the Nth lane 610 of the plurality of lanes 602 may involve accessing the Nth instance 620 of the multiple instances of the VTCM included in the local memory 612.

In some aspects, the local memory 612 may be communicatively coupled to non-lane-wise SIMD coprocessors, such as the SIMD coprocessor 200 of FIG. 2. In this manner, other coprocessors besides the lane-wise SIMD coprocessor 300 may access the local memory 612 to read data from the local memory 612 or write data to the local memory 612.

As will be discussed below in more detail with reference to FIG. 7, the architecture 600 for the lane-wise SIMD coprocessor 300, specifically the plurality of lanes 602 that are decoupled from one another, allows an incoming instruction stream (e.g., a SIMD instruction) to be decoupled into different lanes (e.g., first lane 604, second lane 606, third lane 608, Nth lane 610) and processed in any order without affecting the final result of the instruction stream. Conventional SIMD coprocessors, such as the SIMD coprocessor 200 of FIG. 2, include multiple lanes like the architecture 600 of FIG. 6. But the multiple lanes included in conventional SIMD coprocessors are interlocked (e.g., coupled to one another to support data movement between lanes). Accordingly, architectures for conventional SIMD coprocessors differ from the architecture 600 of FIG. 6 and therefore cannot support processing an instruction stream as discussed below in FIG. 7.

### Example Technique for Processing an Instruction Stream on a Lane-Wise SIMD Coprocessor

FIG. 7 depicts a technique for processing an SIMD instruction 700 on a lane-wise SIMD coprocessor, such as the lane-wise SIMD coprocessor 300 of FIG. 3, according to some aspects of the present disclosure.

As shown, the SIMD instruction 700 may be broadcast to each of the plurality of lanes 602. For instance, as illustrated, a first instance 702 of the SIMD instruction 700 may be provided to the first lane 604 of the plurality of lanes 602. A second instance 704 of the SIMD instruction 700 may be provided to the second lane 606 of the plurality of lanes 602. A third instance 706 of the SIMD instruction 700 may be provided to the third lane 608 of the plurality of lanes 602 and an Nth instance 708 of the SIMD instruction 700 may be provided to the Nth lane 610 of the plurality of lanes 602.

By providing the SIMD instruction 700 to each of the plurality of lanes 602 of the lane-wise SIMD coprocessor 300, the SIMD instruction 700 may be executed within each of the plurality of plurality of lanes 602. Furthermore, since the plurality of lanes 602 are decoupled from one another, the SIMD instruction 700 may be executed in any particular order within each respective lane of the plurality of lanes 602 without affecting a final result of the SIMD instruction 700. In this manner, the above-described technique for processing the SIMD instruction 700 on the lane-wise SIMD coprocessor 300 is improved (e.g., faster) compared to processing of the same SIMD instruction 700 on conventional SIMD coprocessors, such as the SIMD coprocessor 200 of FIG. 2, in which the lanes thereof are interlocked (e.g., not decoupled from one another to prevent data movement between lanes).

### Example Method for Processing a SIMD Instruction on a Lane-Wise SIMD Coprocessor

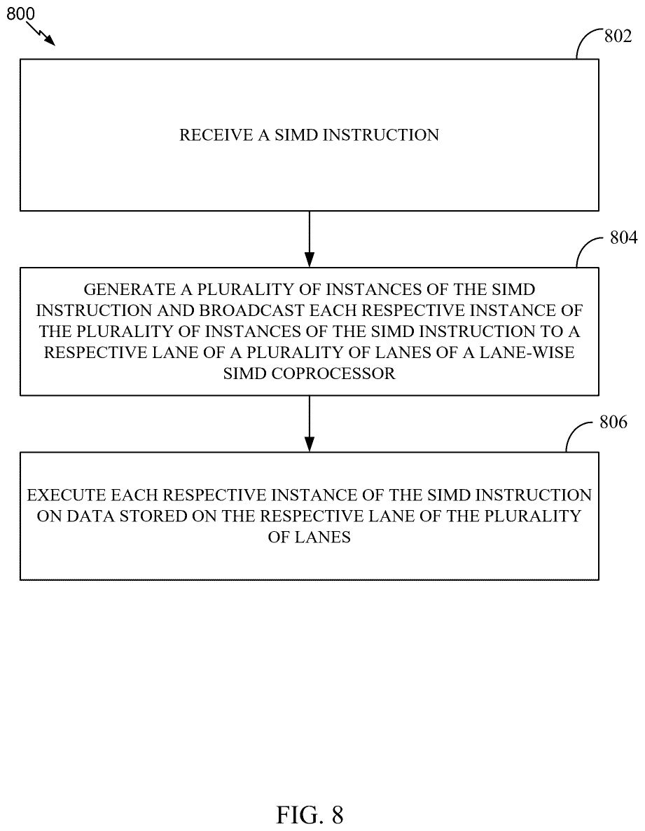

FIG. 8 is a diagram depicting an example method 800 for processing a SIMD instruction on a lane-wise SIMD coprocessor according to various aspects of the present disclosure. For example, the method 800 may be performed by the lane-wise coprocessor 300 of FIG. 3 having the architecture illustrated in FIG. 6. Furthermore, although FIG. 8 depicts steps performed in a particular order for purposes of illustration and discussion, the method 800 discussed herein is not intended to be limited to any particular order or arrangement. One skilled in the art, using the disclosure provided herein, will appreciate that various steps of the method 800 can be omitted, rearranged, combined and/or adapted in various ways without deviating from the scope of the present disclosure.

Operation 802 includes receiving a SIMD instruction packet. For example, the SIMD instruction packet may be the SIMD instruction packet 700 discussed above with reference to FIG. 7. In some aspects, the SIMD instruction comprises one or more register instructions and at least one of a load instruction and a store instruction.

Operation 804 includes broadcasting the SIMD instruction to each lane of a plurality of lanes of a lane-wise SIMD coprocessor. For instance, as discussed above with reference to FIG. 7, a first instance of the SIMD instruction may be broadcast to a first lane of the plurality of lanes; a second instance of the SIMD instruction may be broadcast to a second lane of the plurality of lanes; a third instance of the SIMD instruction may be broadcast to a third lane of the plurality of lanes; and an Nth instance of the SIMD instruction may be broadcast to an Nth lane of the plurality of lanes.

Operation 806 includes executing each respective instance of the SIMD instruction on respective data stored in a corresponding lane of the plurality of lanes. For instance, the first instance of the SIMD instruction may be executed on data stored on the first lane of the plurality of lanes. The second instance of the SIMD instruction may be executed on data stored on the second lane of the plurality of lanes. The third instance of the SIMD instruction may be executed on data stored on the third lane of the plurality of lanes. Finally, the Nth instance of the SIMD instruction may be executed on data stored on the Nth lane of the plurality of lanes.

In some aspects, each of the plurality of lanes of the lane-wise SIMD coprocessor may include a plurality of lane-wise SIMD coprocessors. In such aspects, executing each respective instance of the SIMD instruction on the data stored on the respective lane of the plurality of lanes may involve executing the respective instance of the SIMD instruction on each respective SIMD lane of each respective lane-wise SIMD register included in the respective lane independent occurring between SIMD lanes of the each respective lane-wise SIMD register.

By executing each instance of the SIMD instruction within a respective lane of the plurality of lanes, each instance of the SIMD instruction may be executed in any particular order without affecting the final result of the SIMD instruction. In this manner, processing SIMD instructions according to the above-described method 800 on lane-wise SIMD coprocessors may allow such lane-wise SIMD coprocessors to process SIMD instructions more efficiently (e.g., faster) compared to processing the same SIMD instructions on conventional SIMD coprocessors having multiple lanes that are interlocked (that is, not decoupled from one another to prevent data movement between lanes).

### Example Processing System

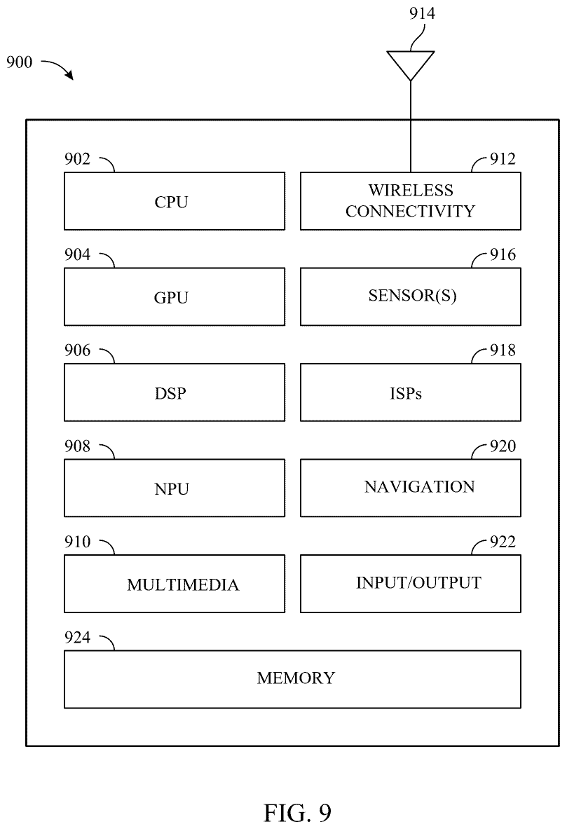

In some aspects, the heterogeneous computing system 100 discussed above with reference to FIG. 1 may be included in a device or processing system. FIG. 9 depicts an example processing system 900. Although depicted as a single system for conceptual clarity, in some aspects, as discussed above, the operations described below with respect to the processing system 900 may be distributed across any number of devices or systems.

The processing system 900 includes a central processing unit (CPU) 902. Instructions executed at the CPU 902 may be loaded, for example, from a memory 924 associated with the CPU 902.

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS), as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

Generally, the processing system 900 and/or components thereof may be configured to perform the methods described herein.

Notably, in other aspects, elements of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 may be distributed between multiple devices.

### Example Clauses

In addition to the various aspects described above, specific combinations of aspects are within the scope of the disclosure, some of which are detailed below:
Aspect 1: A processing system, comprising: a lane-wise single instruction multiple data (SIMD) coprocessor comprising: a plurality of instances of local memory, each respective instance of local memory being decoupled from every other instance of local memory; and a plurality of lanes, wherein each respective lane of the plurality of lanes is coupled to a respective instance of local memory, and wherein each respective lane of the plurality of lanes is decoupled from every other lane of the plurality of lanes, wherein the lane-wise SIMD coprocessor is configured to: receive a SIMD instruction; generate a plurality of instances of the SIMD instruction; broadcast each respective instance of the SIMD instruction to a respective lane of the plurality of lanes; and execute, for each respective instance of the SIMD instruction, one or more operations on respective data stored on the respective lane of the plurality of lanes independent of execution of the one or more operations on respective data stored on every other respective lane of the plurality of lanes.
Aspect 2: The processing system of Aspect 1, wherein to execute, for each respective instance of the SIMD instruction, the one or more operations on the data stored on the respective lane of the plurality of lanes, the lane-wise SIMD coprocessor is configured to access the respective instance of the local memory.
Aspect 3: The processing system of Aspect 1, wherein each respective instance of local memory comprises a vector tightly coupled memory (VTCM).
Aspect 4: The processing system of Aspect 1, wherein to execute, for each respective instance of the SIMD instruction, the one or more operations on the respective data stored on the respective lane of the plurality of lanes, the SIMD coprocessor is configured to execute the one or more operations on the respective data on the respective lane asynchronously relative to execution of the one or more operations on the respective data stored on every other respective lane of the plurality of lanes.
Aspect 5: The processing system of Aspect 1, wherein: a first subset of the plurality of lanes is coupled to a first instance of the local memory, the first subset including a first plurality of lanes; and a second subset of the plurality of lanes is coupled to a second instance of the local memory, the second subset including a second plurality of lanes.
Aspect 6: The processing system of Aspect 5, wherein a total number of lanes included in the first plurality of lanes is different from a total number of lanes included in the second plurality of lanes.
Aspect 7: The processing system of Aspect 5, wherein: the first instance of the local memory comprises a first vector tightly coupled memory (VTCM); and the second instance of the local memory comprises a second VTCM.
Aspect 8: The processing system of Aspect 1, wherein the SIMD instruction comprises one or more register instructions and at least one of a load instruction and a store instruction.
Aspect 9: The processing system of Aspect 8, wherein the SIMD instruction comprises the load instruction and the store instruction.
Aspect 10: A method performable by a single instruction multiple data (SIMD) coprocessor comprising a plurality of instances of local memory and a plurality of lanes, each respective lane of the plurality of lanes coupled to a respective instance of the plurality of instances of local memory, each respective lane of the plurality of lanes decoupled from every other lane of the plurality of lanes, the method comprising: receiving a SIMD instruction; generating a plurality of instances of the SIMD instruction; broadcasting each respective instance of the SIMD instruction to a respective lane of the plurality of lanes of the SIMD coprocessor; and executing, for each respective instance of the SIMD instruction, one or more operations on respective data stored on the respective lane of the plurality of lanes independent of execution of the one or more operations on respective data stored on every other respective lane of the plurality of lanes.
Aspect 11: The method of Aspect 10, wherein executing, for each respective instance of the SIMD instruction, the one or more operations on the data stored on the respective lane of the plurality of lanes comprises accessing the respective instance of the local memory.
Aspect 12: The method of Aspect 10, wherein each respective instance of local memory comprises a vector tightly coupled memory (VTCM).
Aspect 13: The method of Aspect 10, wherein executing, for each respective instance of the SIMD instruction, the one or more operations on the respective data stored on the respective lane of the plurality of lanes comprises executing the one or more operations on the respective data on the respective lane asynchronously relative to execution of the one or more operations on the respective data stored on every other respective lane of the plurality of lanes.
Aspect 14: The method of Aspect 10, wherein the plurality of a first subset of the plurality of lanes is coupled to a first instance of the local memory, the first subset including a first plurality of lanes; and a second subset of the plurality of lanes is coupled to a second instance of the local memory, the second subset including a second plurality of lanes.
Aspect 15: The method of Aspect 14, wherein a total number of lanes included in the first subset of lanes is different from a total number of lanes included in the second subset of lanes.
Aspect 16: The method of Aspect 14, wherein: the first instance of the local memory comprises a first vector tightly coupled memory (VTCM); and the second instance of the local memory comprises a second VTCM.
Aspect 17: The method of Aspect 10, wherein the SIMD instruction comprises one or more register instructions and at least one of a load instruction and a store instruction.
Aspect 18: The method of Aspect 10, wherein the SIMD instruction comprises the load instruction and the store instruction.
Aspect 19: A processing system, comprising: a lane-wise SIMD coprocessor comprising a plurality of lanes, each respective lane of the plurality of lanes being decoupled from every other lane included in the plurality of lanes, wherein the lane-wise SIMD coprocessor is configured to: receive a SIMD instruction; generate a plurality of instances of the SIMD instruction; broadcast each respective instance of the SIMD instruction to a respective lane of the plurality of lanes; and execute, for each respective instance of the SIMD instruction, one or more operations on respective data stored on the respective lane of the plurality of lanes independent of execution of the one or more operations on respective data stored on every other respective lane of the plurality of lanes.
Aspect 20: The processing system of Aspect 19, wherein to execute, for each respective instance of the SIMD instruction, the one or more operations on the respective data stored on the respective lane of the plurality of lanes, the SIMD coprocessor is configured to execute the one or more operations on the respective data on the respective lane asynchronously relative to execution of the one or more operations on the respective data stored on every other respective lane of the plurality of lanes.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
a lane-wise single instruction multiple data (SIMD) coprocessor comprising:
a plurality of instances of local memory, each respective instance of local memory being decoupled from every other instance of local memory; and
a plurality of lanes, wherein each respective lane of the plurality of lanes is coupled to a respective instance of local memory, and wherein each respective lane of the plurality of lanes is decoupled from every other lane of the plurality of lanes,
wherein the lane-wise SIMD coprocessor is configured to:
receive a SIMD instruction;
generate a plurality of instances of the SIMD instruction;
broadcast each respective instance of the SIMD instruction to a respective lane of the plurality of lanes; and
execute, for each respective instance of the SIMD instruction, one or more operations on respective data stored on the respective lane of the plurality of lanes independent of execution of the one or more operations on respective data stored on every other respective lane of the plurality of lanes.

2. The processing system of claim 1, wherein to execute, for each respective instance of the SIMD instruction, the one or more operations on the data stored on the respective lane of the plurality of lanes, the lane-wise SIMD coprocessor is configured to access the respective instance of the local memory.

3. The processing system of claim 1, wherein each respective instance of local memory comprises a vector tightly coupled memory (VTCM).

4. The processing system of claim 1, wherein to execute, for each respective instance of the SIMD instruction, the one or more operations on the respective data stored on the respective lane of the plurality of lanes, the SIMD coprocessor is configured to execute the one or more operations on the respective data on the respective lane asynchronously relative to execution of the one or more operations on the respective data stored on every other respective lane of the plurality of lanes.

5. The processing system of claim 1, wherein:
a first subset of the plurality of lanes is coupled to a first instance of the local memory, the first subset including a first plurality of lanes; and
a second subset of the plurality of lanes is coupled to a second instance of the local memory, the second subset including a second plurality of lanes.

6. The processing system of claim 5, wherein a total number of lanes included in the first plurality of lanes is different from a total number of lanes included in the second plurality of lanes.

7. The processing system of claim 5, wherein:
the first instance of the local memory comprises a first vector tightly coupled memory (VTCM); and
the second instance of the local memory comprises a second VTCM.

8. The processing system of claim 1, wherein the SIMD instruction comprises one or more register instructions and at least one of a load instruction and a store instruction.

9. The processing system of claim 8, wherein the SIMD instruction comprises the load instruction and the store instruction.

10. A method performable by a single instruction multiple data (SIMD) coprocessor comprising a plurality of instances of local memory and a plurality of lanes, each respective lane of the plurality of lanes coupled to a respective instance of the plurality of instances of local memory, each respective lane of the plurality of lanes decoupled from every other lane of the plurality of lanes, the method comprising:
receiving a SIMD instruction;
generating a plurality of instances of the SIMD instruction;
broadcasting each respective instance of the SIMD instruction to a respective lane of the plurality of lanes of the SIMD coprocessor; and
executing, for each respective instance of the SIMD instruction, one or more operations on respective data stored on the respective lane of the plurality of lanes independent of execution of the one or more operations on respective data stored on every other respective lane of the plurality of lanes.

11. The method of claim 10, wherein executing, for each respective instance of the SIMD instruction, the one or more operations on the data stored on the respective lane of the plurality of lanes comprises accessing the respective instance of the local memory.

12. The method of claim 10, wherein each respective instance of local memory comprises a vector tightly coupled memory (VTCM).

13. The method of claim 10, wherein executing, for each respective instance of the SIMD instruction, the one or more operations on the respective data stored on the respective lane of the plurality of lanes comprises executing the one or more operations on the respective data on the respective lane asynchronously relative to execution of the one or more operations on the respective data stored on every other respective lane of the plurality of lanes.

14. The method of claim 10, wherein:
the plurality of lanes comprises a first subset of lanes that is coupled to a first instance of the local memory and a second subset of lanes that is coupled to a second instance of the local memory;
generating comprises generating a first instance of the SIMD instruction for the first subset of lanes and generating a second instance of the SIMD instruction for the second subset of lanes.

15. The method of claim 14, wherein a total number of lanes included in the first subset of lanes is different from a total number of lanes included in the second subset of lanes.

16. The method of claim 14, wherein:
the first instance of the local memory comprises a first vector tightly coupled memory (VTCM); and
the second instance of the local memory comprises a second VTCM.

17. The method of claim 14, wherein the SIMD instruction comprises one or more register instructions and at least one of a load instruction and a store instruction.

18. The processing system of claim 8, wherein the SIMD instruction comprises the load instruction and the store instruction.

19. A processing system, comprising:
a lane-wise SIMD coprocessor comprising a plurality of lanes, each respective lane of the plurality of lanes being decoupled from every other lane included in the plurality of lanes,
wherein the lane-wise SIMD coprocessor is configured to:
receive a SIMD instruction;
generate a plurality of instances of the SIMD instruction;
broadcast each respective instance of the SIMD instruction to a respective lane of the plurality of lanes; and
execute, for each respective instance of the SIMD instruction, one or more operations on respective data stored on the respective lane of the plurality of lanes independent of execution of the one or more operations on respective data stored on every other respective lane of the plurality of lanes.

20. The processing system of claim 19, wherein to execute, for each respective instance of the SIMD instruction, the one or more operations on the respective data stored on the respective lane of the plurality of lanes, the SIMD coprocessor is configured to execute the one or more operations on the respective data on the respective lane asynchronously relative to execution of the one or more operations on the respective data stored on every other respective lane of the plurality of lanes.
